(19) United States
(12) Patent Application Publication
(10) Pub. No.: US 2010/0253893 A1
(43) Pub. Date: Oct. 7, 2010

(54) DISPLAY FILTER FOR LCD HAVING ANTI-FOG LAYER

(75) Inventors: Dong Keun SHIN, ChungCheongNam-Do (KR); Dae Chul Park, ChungCheongNam-Do (KR); Shin Wook Kim, ChungCheongNam-Do (KR); Dong Hyun Park, ChungCheongNam-Do (KR); Dong Hwal Lee, ChungCheongNam-Do (KR)

Correspondence Address: MCDERMOTT WILL & EMERY LLP, 600 13TH STREET, N.W., WASHINGTON, DC, 20005-3096, US

(73) Assignee: SAMSUNG CORNING PRECISION GLASS CO., LTD.

(21) Appl. No.: 12/730,891

(22) Filed: Mar. 24, 2010

(30) Foreign Application Priority Data
Apr. 1, 2009 (KR) 10-2009-0028082

(51) Int. Cl. G02F 1/1333

(52) U.S. Cl. 349/122

(57) ABSTRACT

A display filter for a Liquid Crystal Display (LCD) having an anti-fog function includes a transparent support arranged in front of the display module and an anti-fog layer stacked in the rear of the transparent support to face the display module. The anti-fog layer prevents the display filter from fogging up.

### CROSS REFERENCE TO RELATED APPLICATION

The present application claims priority from Korean Patent Application Number 10-2009-0028082 filed on Apr. 1, 2009, the entire contents of which application is incorporated herein for all purposes by this reference.

### BACKGROUND OF THE INVENTION

1. Field of the Invention

The present invention relates to a display filter, and more particularly, to a display filter for a Liquid Crystal Display (LCD) having an anti-fog function.

2. Description of Related Art

As a consequence of the development of display technologies, a variety of flat panel display devices have been distributed in the market. The most prominent display devices are an LCD device (used as a monitor and a TV) and a Plasma Display Panel (PDP) device. At present, the PDP and the LCD are intensively competing with each other, since they have different advantages and disadvantages in many aspects.

In terms of image quality, the PDP produces color that seems more natural and smooth than the LCD does. However, to the user's eye, the LCD looks clearer since it is brighter. In terms of response time, the PDP is faster than the LCD since the PDP itself can emit light while the LCD requires backlighting. Therefore, the LCD is sometimes afflicted with afterimage.

In terms of viewing angle, the PDP is superior to the LCD. However, the viewing angle of the LCD has been gradually increasing. In terms of power consumption, the PDP and the LCD consume a similar amount of power for 40 inch screens. However, for screens of 50 inches or more, the PDP consumes more power than the LCD does.

Recently, many LCD monitors and TVs employ a display filter (including a filter that consists only of protective glass) in order to improve durability, optical characteristics, and the like. However, when the display filter is used in the LCD monitor/TV, fog can occur inside the LCD monitor/TV due to the temperature difference between the inside and outside thereof. In general, the PDP can quickly eliminate fog (i.e., mist) since it emits a sufficient amount of heat from the PDP module immediately after being powered on. However, it is fundamentally difficult for the LCD to remove fog (mist) since only a small amount of heat is emitted from an LCD module.

Meanwhile, the LCD monitor/TV uses an anti-glare film in order to protect a user from glare. Recently, the demand for an alternative that can prevent glare without using the anti-glare film in the LCD monitor/TV has arisen, in order to improve price competitiveness.

The information disclosed in this Background of the Invention section is only for the enhancement of understanding of the background of the invention and should not be taken as an acknowledgment or any form of suggestion that this information forms a prior art that would already be known to a person skilled in the art.

### BRIEF SUMMARY OF THE INVENTION

Various aspects of the present invention provide a display filter for a Liquid Crystal Display (LCD) having an anti-fog function.

Also provided is a display filter for an LCD having an anti-fog function that also includes an anti-glare function.

In an aspect of the present invention, the display filter, inside which the display module is mounted, may include a transparent support arranged in front of the display module and an anti-fog layer stacked in the rear of the transparent support to face the display module, the anti-fog layer preventing the display filter from fogging up.

According to an exemplary embodiment of the invention, the anti-fog layer may include a Pressure-Sensitive Adhesive (PSA) layer formed on the transparent support, a Triacetate Cellulose (TAC) film formed on the PSA layer, and a hydrophilic layer formed on the TAC film.

According to an exemplary embodiment of the invention, the transparent support may have a compressive strength of 25 MPa or more. Furthermore, the PSA layer may include light scattering beads.

According to the exemplary embodiments of the present invention as set forth above, the display filter has the anti-fog layer formed in front of the LCD display module. This can result in the advantageous effect of preventing the display filter in front of the LCD display module from fogging up.

In addition, since the transparent support of the display filter has a high compressive strength, the display filter can maintain its performance without being damaged by the shrinkage of a hydrophilic layer even if extreme shrinkage occurs in the hydrophilic layer due to high temperatures or high moisture.

Furthermore, since the PSA layer of the display filter contains light scattering beads therein, it can advantageously protect the user from glare, thereby reducing eye fatigue.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a view schematically showing the structure of an LCD that uses a display filter according to an exemplary embodiment of the invention;

FIG. 2 is a view schematically showing the structure of the display filter according to the exemplary embodiment of the invention; and

FIG. 3 is an illustration a hydrophilic layer according to the exemplary embodiment of the invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

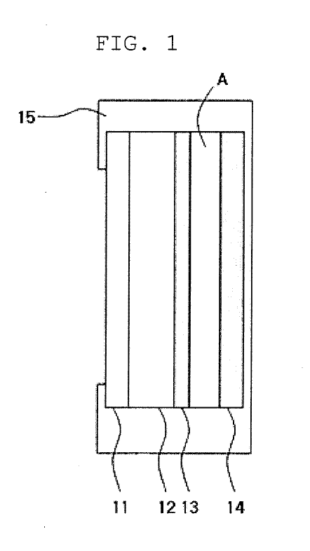

FIG. 1 is a view schematically showing the structure of an LCD that uses a display filter according to an exemplary embodiment of the invention.

As shown in the figure, the LCD generally includes an anti-reflection film 11, a transparent support 12, an anti-fog layer 13, a display module 14, and an exterior case 15.

The anti-reflection film 11 serves to improve visibility by preventing the reflection of ambient light. As an example, the anti-reflection film 11 can be a film in which a plurality of high-refractivity layers made of an inorganic material, such as Indium Tin Oxide (ITO), TiO₂, or ZrO₂, and a plurality of low-refractivity layers made of an inorganic material, such as SiO2 or MgF2, are formed alternately on a transparent substrate. In another embodiment, the anti-reflection film 11 can be a film in which a hard coating layer having a refractivity of 1.5 or more is formed on a Polyethylene Terephthalate (PET) film or a Triacetate Cellulose (TAC) film and a low-refractivity layer having a refractivity of 1.5 or less is formed on the hard coating layer.

The anti-reflection film 11 is attached onto one side of the transparent support and the anti-fog layer 13 is attached onto the other side of the transparent support. It is preferable that the transparent support 12 be made of a material that can endure extreme shrinkage of the anti-fog layer 13, which is caused by a rapid change in temperature or high humidity. The inventors of this application found that the transparent support 12 does not break when it has a compressive strength of 25 MPa or more. The transparent support 12 can be, for example, a tempered glass having a compressive strength of 25 MPa or more.

The anti-fog layer 13 is formed on the rear surface of the transparent support 12 such that it faces the display module 14. The anti-fog layer 13 serves to absorb moisture, which is created in an inner space A due to a change in temperature or high humidity, or prevent the condensation of moisture in the form of small droplets on the surface thereof, thereby preventing fogging.

The anti-fog layer 13 can include a hydrophilic layer that contains a hydrophilic group, such as a hydroxyl group (OH—), a sulfonic group (—SO₃H), a carboxyl group (—COOH), or an amino group (—NH₂). The hydrophilic layer containing a hydrophilic group can be formed on the transparent support 12 or can be formed on the surface of a hydrophobic film through a reaction with a hydroxylating agent.

In addition, although not shown in FIG. 1, the display filter according to the exemplary embodiment of the invention can also include a functional optical film between the transparent support 12 and the anti-fog layer 13. The functional optical film can be, for example, a light-absorbing film that absorbs a specific wavelength range of visible light that is emitted from the display module.

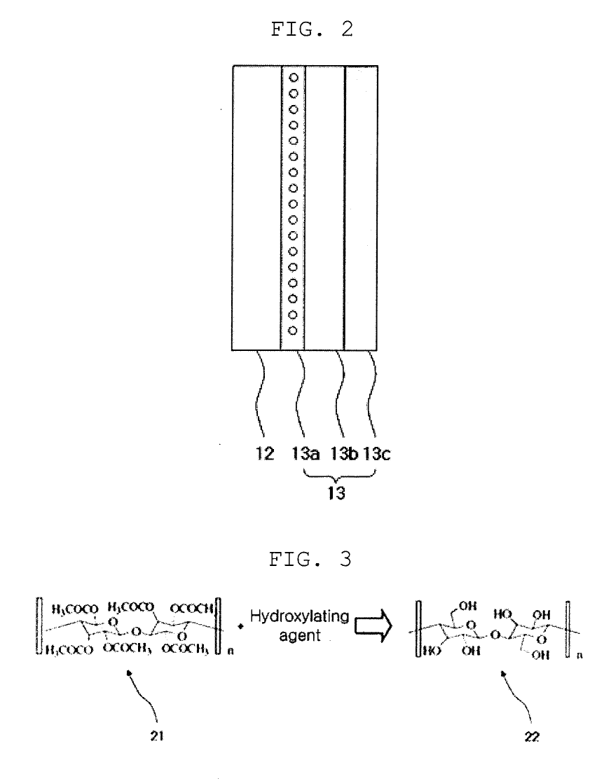

FIG. 2 is a view schematically showing the structure of the display filter according to the exemplary embodiment of the invention.

As shown in the figure, the anti-fog layer 13 of the exemplary embodiment includes a Pressure-Sensitive Adhesive (PSA) layer 13a formed on the transparent support 12, a base film 13b formed on the PSA layer 13a, and a hydrophilic layer 13c formed on the base film 13b.

One side of the PSA layer 13a is attached to the transparent support 12, and a TAC film 13b is attached to the other side of the PSA layer 13a. The PSA layer 13a can be manufactured by dissolving or emulsifying an adhesive polymeric material using a dispersion medium, such as water or an organic solvent.

According to a characteristic aspect of the invention, the PSA layer 13a includes light scattering beads. For example, the light scattering beads can be glass beads that have a diameter of 10 μm or less and haze (i.e., opacity) of 5% or less. In addition, the light scattering beads can be melamine beads (refractivity: 1.57), acrylic beads (refractivity: 1.47), acrylic-styrene beads (refractivity: 1.54), polycarbonate beads, polyethylene beads, vinyl chloride beads, or the like. In addition, the PSA layer 13 can include a light-absorbing material added thereto.

The base film 13b is used to form the hydrophilic layer 13c. Although the base film 13b used in the LCD is typically hydrophobic, the base film is surface-modified to form the hydrophilic layer 13c thereon through a chemical reaction with a hydroxylating agent according to the exemplary embodiment of the invention. For example, the base film can be a TAC film.

Although the anti-fog layer 13 has been illustrated as including the PSA layer 13a so that the base film 13b can be attached to the transparent support 12, the present invention is not limited thereto. Rather, the anti-fog layer 13 may use other adhesives instead of the PSA. In addition, the base film 13b of the anti-fog layer 13 can be formed directly on the transparent support 12 without the use of the PSA layer 13a.

FIG. 3 is an illustration explaining the hydrophilic layer according to the exemplary embodiment of the invention.

Hydroxyl (OH—) compound 22 which is hydrophilic material, is formed on a hydrophobic film including methyl ester (COOCH₃) compound 21, when the hydrophobic film is subjected to chemical reaction with hydroxylating agent. For example, when the methyl ester (COOCH₃) compound 21 is immersed into a sodium chloride or potassium chloride solution at 50° C. for several seconds, the hydroxyl (OH—) compound 22 is formed through esterification.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A display filter used for a liquid crystal display, inside which a display module is mounted, the display filter arranged in front of the display module and comprising:
a transparent support; and
an anti-fog layer stacked in the rear of the transparent support to face the display module, the anti-fog layer preventing the display filter from fogging up.

2. The display filter according to claim 1, wherein the anti-fog layer is hydrophilic.

3. The display filter according to claim 2, wherein the anti-fog layer comprises:
a base film; and
a hydrophilic layer formed on a rear surface of the base film.

4. The display filter according to claim 3, wherein the base film comprises a triacetate cellulose film.

5. The display filter according to claim 3, wherein the hydrophilic layer is a surface-modified layer of the base film by hydroxylation.

6. The display filter according to claim 3, further comprising a Pressure-Sensitive adhesive layer formed on a front surface of the base film, which faces the transparent support, wherein the Pressure-Sensitive adhesive layer includes light scattering beads.

7. The display filter according to claim 1, wherein the transparent support comprises a material having a compressive strength of 25 MPa or more.

8. The display filter according to claim 7, wherein the transparent support comprises a tempered glass.
